(19) United States
(12) Patent Application Publication
(10) Pub. No.: US 2026/0101906 A1
(43) Pub. Date: Apr. 16, 2026

(54) Method of Manufacturing a Ready-to-Drink Infused Beverage Containing Atmospheric-Plasma-Treated Protein

(71) Applicant: BRIAN D. HAYMAKER, STONY POINT, NC (US)

(72) Inventor: BRIAN D. HAYMAKER, STONY POINT, NC (US)

(21) Appl. No.: 19/355,875

(22) Filed: Oct. 10, 2025

Related U.S. Application Data
(60) Provisional application No. 63/705,888, filed on Oct. 10, 2024.

(51) Int. Cl. A23F 3/16; A23F 3/18; A23F 3/34; A23F 3/40; A23J 3/04; A23J 3/08; A23J 3/14; B67C 3/22; B67C 7/00

(52) U.S. Cl. CPC A23F 3/163; A23F 3/18; A23F 3/34; A23F 3/405; A23J 3/04; A23J 3/08; A23J 3/14; B67C 3/22; B67C 7/00

(57) ABSTRACT

A method of manufacturing a Ready-to-Drink (RTD) infused beverage containing atmospheric-plasma-treated protein. A quantity of protein is atmospheric-plasma treated to produce a quantity of plasma-treated protein. An infusion base is also brewed using a quantity of brewing water and a quantity of infusion materials at a specific brewing temperature. Then, the quantity of plasma-treated protein is dispersed into the infusion base to make a beverage mixture. A quantity of sweeteners and a quantity of preservatives are mixed into the beverage mixture. Then, the beverage mixture pH is adjusted to match a specific mixture pH using a quantity of pH control agents. Afterwards, the beverage container is filled with the beverage mixture. Once the beverage container is filled, the beverage container is then nitrogen-dosed and then sealed. Finally, the beverage container is pasteurized after the beverage container is sealed.

### FIELD OF THE INVENTION

The present invention relates generally to protein products and consumable beverages. More specifically, the present invention provides a method of manufacturing infused beverages that include atmospheric-plasma-treated protein for improved solubility, stability, and bioavailability.

### BACKGROUND OF THE INVENTION

Protein-fortified beverages are widely consumed for health, nutrition, and athletic performance. However, integrating protein into Ready-to-Drink (RTD) infused formulations presents significant challenges, including protein aggregation, foaming, undesirable mouthfeel, and reduced bioavailability. Conventional protein beverages are frequently formulated either as high-viscosity, milkshake-type products with elevated pH values, or as carbonated protein seltzers. Both categories typically require powder reconstitution, which can result in incomplete dissolution, clumping, and consumer inconvenience. While micronization and certain solubilization techniques are known, existing methods often fail to produce a smooth, stable beverage with enhanced bioavailability, high protein content, and clean label appeal. There remains a need for an RTD infused beverage that incorporates protein in such a way that:
The protein dissolves substantially in the infusion base with minimal visible sedimentation,
The infused beverage retains desirable flavor and mouthfeel,
The infused beverage maintains stability during shelf life,
The infused beverage is highly bioavailable upon consumption, and
The infused beverage uses an efficient, scalable manufacturing process suitable for commercial production.

### SUMMARY OF THE INVENTION

The present invention provides a method of manufacturing a Ready-to-Drink (RTD) infused beverage containing atmospheric-plasma-treated protein. The RTD infused beverage of the present invention includes a Camellia-sinensis-based or non-Camellia-sinensis-based infusion that is mixed with atmospheric-plasma-treated micronized protein. The RTD infused beverage can also include, but is not limited to, one or more natural sweeteners, natural preservatives, and natural flavors. The resulting RTD infused beverage is a light-refreshing tea-like beverage that is optimized for stability and flavor. Further, different types of protein can be mixed into the RTD infused beverage, and the chosen protein is treated with atmospheric plasma to micronize the protein.

Micronizing is a process that involves reducing a substance into a fine powder, in which the particles of the substance are measured in microns. Micronized protein can be dissolved thoroughly into the RTD infused beverage. If the protein is not micronized, the RTD infused beverage becomes a thick chunky beverage as there are remaining particles that are unable to be fully dissolved. Using the atmospheric plasma treatment process, the protein is micronized at the molecular level so that the consistency or taste of the RTD infused beverage is not affected. Thus, the RTD infused beverage is substantially free of visible protein sedimentation for more than 12 months. Additional features and benefits of the present invention are further discussed in the sections below.

### BRIEF DESCRIPTION OF THE DRAWINGS

FIG. 1 is a schematic view for a manufacturing method of the Ready-to-Drink (RTD) infused beverage of the present invention.

FIG. 2 is a schematic view for the continuation of the manufacturing method of the present invention shown in FIG. 1.

FIG. 3 is a flowchart illustrating the overall process of the manufacturing method of the present invention.

FIG. 4 is a flowchart illustrating the continuation of the overall process of the manufacturing method shown in FIG. 3.

FIG. 5 is a flowchart illustrating the subprocess of treating the protein with atmospheric plasma of the present invention.

FIG. 6 is a flowchart illustrating the subprocess of adding flavoring to the beverage mixture of the present invention.

FIG. 7 is a flowchart illustrating the subprocess of infusing the secondary brewing ingredients into the infusion base of the present invention.

FIG. 8 is a flowchart illustrating the subprocess of carbonating the beverage mixture of the present invention.

FIG. 9 is a flowchart illustrating the subprocess of producing concentrates/extracts from the infusion materials of the present invention.

### DETAIL DESCRIPTIONS OF THE INVENTION

All illustrations of the drawings are for the purpose of describing selected versions of the present invention and are not intended to limit the scope of the present invention.

The present invention provides a method of manufacturing a Ready-to-Drink (RTD) infused beverage containing atmospheric-plasma-treated protein. The RTD infused beverage of the present invention is a 100% lactose free, Non-Genetically Modified Organism (GMO), gluten free beverage that is perfect for people with dietary sensitivities. In addition, the RTD infused beverage has zero sugar and has low calories which helps individuals make informed decisions about food choices for guilt-free consumption. Furthermore, the RTD infused beverage provides enough high-quality protein with the maximum absorption per serving.

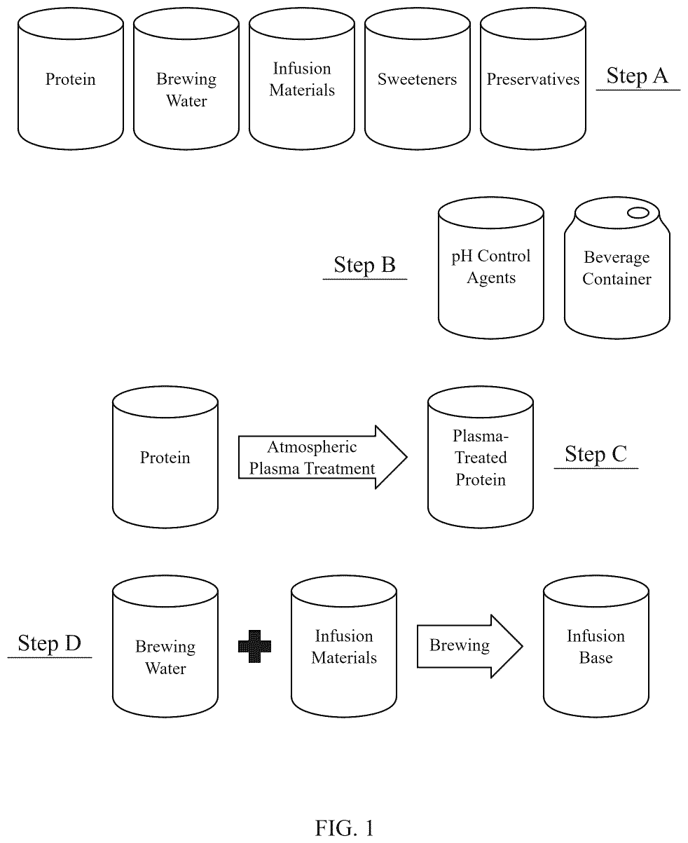

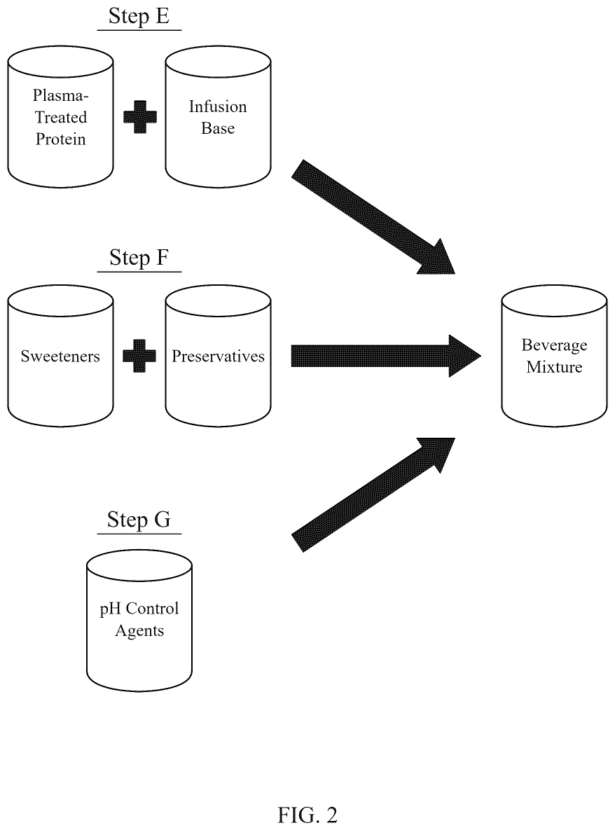

To produce the RTD infused beverage, the present invention provides a method for manufacturing that is efficient, scalable, and suitable for commercial production. As can be seen in FIGS. 1 and 2, to start the manufacturing process, the main beverage ingredients are collected which include a quantity of brewing water, a quantity of infusion materials, a quantity of protein, a quantity of sweeteners, and a quantity of preservatives (Step A). Depending on the volume of the batch being manufactured, the quantity of each beverage ingredient may vary due to the scalability of the manufacturing method. Further, at least one beverage container and a quantity of pH control agents are secured (Step B) to store the produced beverage and control the final pH levels of the beverage, respectively.

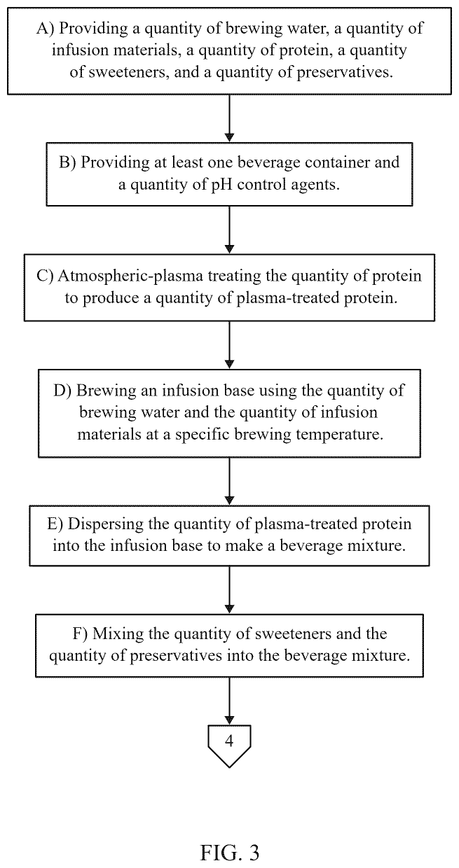

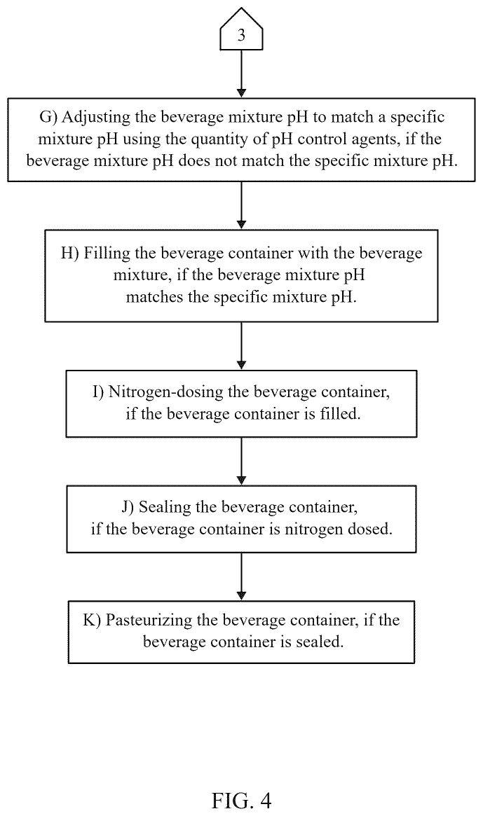

Once the necessary beverage ingredients and manufacturing tools are secured, the manufacturing process can be started. As can be seen in FIGS. 3 and 4, the overall process of the method of the present invention begins with atmospheric-plasma treating the quantity of protein to produce a quantity of plasma-treated protein (Step C). The quantity of protein is plasma-treated to modify the protein surface and micronize the protein particle which enhances the solubility and bioavailability of the quantity of protein. In addition, an infusion base is brewed using the quantity of brewing water and the quantity of infusion materials at a specific brewing temperature (Step D). The infusion base is brewed using the selected infusion materials with low solid concentration to reduce the visible sedimentation of the RTD infused beverage. Once the quantity of protein has been plasma treated and the infusion base is brewed, the quantity of plasma-treated protein is dispersed into the infusion base to make a beverage mixture (Step E). Depending on the target batch volume and manufacturing tools utilized, different mixing methods can be implemented.

Once the beverage mixture is acquired, the quantity of sweeteners and the quantity of preservatives are mixed into the beverage mixture (Step F), as can be seen in FIGS. 3 and 4. Depending on the types of sweeteners and preservatives utilized, specific techniques and tools may be utilized. Further, once the main beverage ingredients have been mixed, if the beverage mixture pH does not match a specific mixture pH, the beverage mixture pH is adjusted to match the specific mixture pH using the quantity of pH control agents (Step G). The specific mixture pH corresponds to a predetermined pH level that ensures stability of the beverage mixture as well as the flavor.

After the beverage mixture has been prepared, the beverage mixture is ready for packaging. As can be seen in FIGS. 3 and 4, before the beverage container is pasteurized, the beverage container is filled with the beverage mixture (Step H), if the beverage mixture pH matches the specific mixture pH. The beverage container must be hot filled. Different types of beverage containers can be utilized depending on the beverage mixture, such as a can or bottle. In addition, the beverage container can be made from different food-grade materials including, but not limited to, aluminum, glass, Polyethylene Terephthalate (PET), aseptic cartons, etc. Further, the beverage container is nitrogen-dosed (Step I), if the beverage container is filled. Nitrogen dosing helps prolong the shelf life of the beverage mixture by displacing oxygen from the beverage container. This prevents oxidation and microbial growth in the beverage container. Then, the beverage container is sealed (Step J), if the beverage container is nitrogen dosed. Once the beverage container is sealed, the beverage container is pasteurized (Step K). Pasteurizing the beverage container helps prolong the preservation of the beverage mixture. In other embodiments, different packaging processes can be implemented for different types beverage containers. Furthermore, the filling process can be modified so that the beverage container filling can be performed aseptically or cold.

As previously discussed, the atmospheric-plasma treatment of the quantity of protein helps improve the quality of the RTD infused beverage without affecting the nutritional composition of the beverage mixture. The atmospheric-plasma treatment can be performed by a third party or performed on-site according to the technological capabilities of the manufacturing facility used. In general, the quantity of protein is preferably provided in powder form before being treated with atmospheric plasma. The chosen protein can also be optionally pre-milled before the atmospheric plasma treatment. Additional preparation processes can be implemented as necessary before the atmospheric plasma treatment.

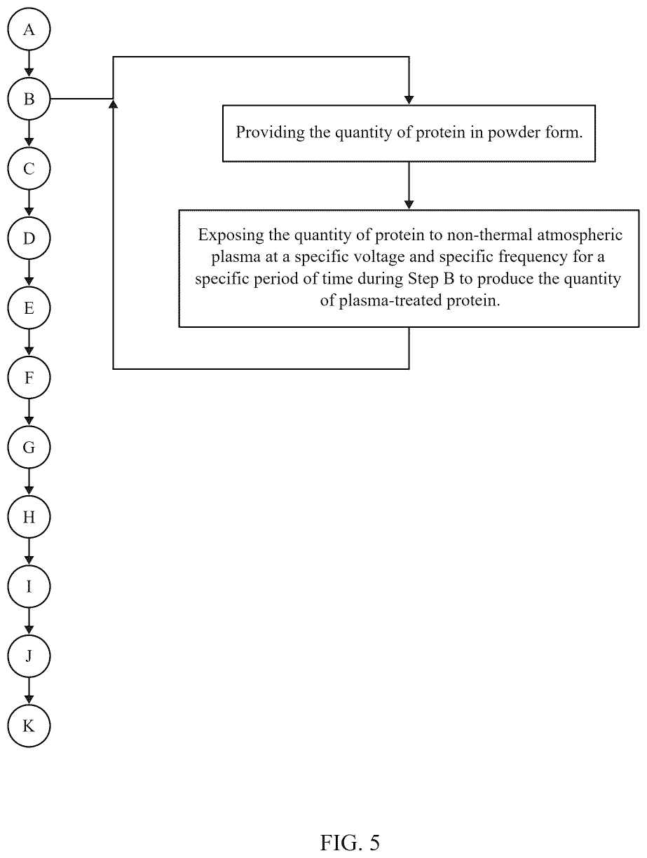

As can be seen in FIG. 5, the general subprocess of treating the protein with atmospheric plasma includes the step of exposing the quantity of protein to non-thermal atmospheric plasma at a specific voltage and specific frequency for a specific period of time during Step B to produce the quantity of plasma-treated protein. Depending on the technology utilized, the treatment variables can change. After the atmospheric-plasma treatment, the quantity of plasma-treated protein has an average particle size in the range of 10 to 25 microns. In other embodiments, the atmospheric-plasma treatment can be modified to achieve different physical properties on the quantity of protein.

The overall composition of the RTD infusion beverage can change according to the desired flavor of the beverage mixture. During the brewing process (Step D), the specific brewing temperature can change according to the infusion materials being used. Generally, the specific brewing temperature is below 60 degrees Celsius and the infusion base yields infusion solids in the range of 0.4% to 3.0%. Further, the specific mixture pH is acidic for optimized stability of the final beverage mixture as well as to enhance the flavor of the beverage mixture. The specific mixture pH is in the range of 3.0 to 4.2, but different pH level ranges can be implemented. For example, the specific mixture pH range can be 3.2 to 3.9, 3.3 to 3.6, etc.

As previously discussed, different infusion materials can be utilized for the infusion base. In some embodiments, the quantity of infusion materials includes at least one camellia-sinensis-based material selected from a group consisting of: black tea, green tea, oolong tea, white tea, Pu-erh tea, yellow tea, or combinations thereof. Infusions are prepared from tea leaves of the chosen species of Camellia Sinensis. In other embodiments, the quantity of infusion materials includes at least one non-camellia-sinensis-based material selected from a group consisting of: rooibos, hibiscus, chamomile, peppermint, ginger, lemongrass, lavender, yerba maté, guayusa, fennel, or combinations thereof. The non-camellia-sinensis-based materials (i.e., tisanes or non-caffeinated teas) provide a wider range of flavor options.

Similar to the infusion materials, the types of protein used for the RTD infused beverage of the present invention can vary depending on the type of beverage desired.

Generally, the quantity of protein includes at least one protein material selected from a group consisting of: plant-derived protein, animal-derived protein, or combinations thereof. Animal-derived protein used can include, but is not limited to, whey protein isolate, collagen, etc. Plant-derived protein can include, but is not limited to, pea protein, rice protein, mung bean protein, etc. The animal-derived protein and the plant-derived protein can be used individually or blended as necessary. Regardless of the protein used for the beverage mixture, the mass fraction of the quantity of protein in the beverage mixture is in the range of 2.0% to 6.5% by weight (wt.). In other embodiments, different types of protein can be implemented in different concentrations.

Further, depending on the type of RTD infused beverage desired, different types of sweeteners can be utilized. The quantity of sweeteners can include at least one low-calorie sweetener selected from a group consisting of: erythritol, stevia Reb M, monk fruit juice concentrate, allulose, or combinations thereof. Erythritol can be implemented in the 1.0% to 3% wt. % range, stevia Reb M in the 0.05% to 0.2% wt. % range, monk fruit juice concentrate in the 0.1% to 0.5% wt. % range, etc. The chosen sweetener can be natural or biosynthetic as long as the caloric contribution to the beverage mixture is relative negligible when compared to sucrose.

Similar to the sweeteners used, the type of preservatives used can vary according to the beverage ingredients used for the RTD infused beverage. In some embodiments, the quantity of preservatives may include a quantity of mushroom extract. The quantity of mushroom extract can be implemented in the 0.1% to 0.2% wt. % range. In other embodiments, the quantity of preservatives may include at least one pH-reducing agent selected from a group consisting of: citric acid, ascorbic acid, phosphoric acid, malic acid, lactic acid, or combinations thereof. In other embodiments, biotechnology-derived preservatives can be utilized.

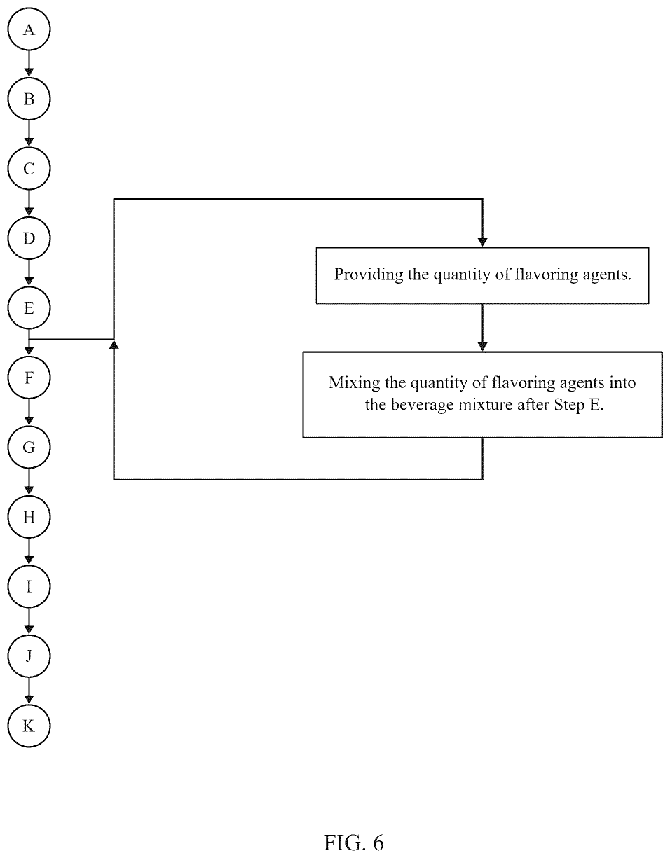

In some embodiments, the beverage mixture can be flavored to further enhance the quality of the RTD infused beverage. So, the beverage ingredients of the present invention may further include a quantity of flavoring agents. The quantity of flavoring agents include at least one natural flavoring selected from a group consisting of: fruit extracts, botanical extracts, spice extracts, or combinations thereof. As can be seen in FIG. 6, the subprocess of adding flavoring to the beverage mixture includes the step of mixing the quantity of flavoring agents into the beverage mixture after Step E. Depending on the type of flavoring agent used, the chosen flavoring agent may be mixed into the beverage mixture at different stages of the manufacturing process.

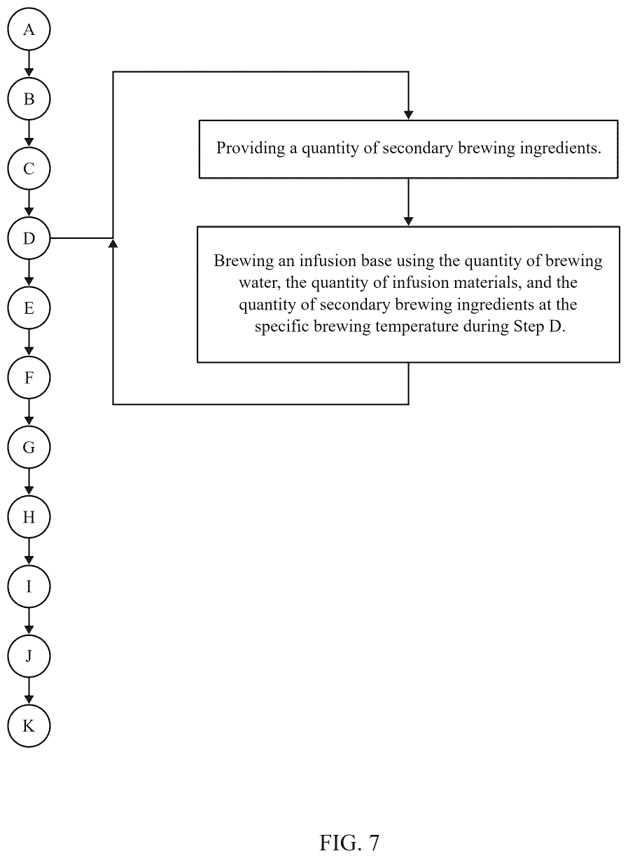

In some embodiments, the infusion base can further include other infusion ingredients to enhance the flavoring or composition of the beverage mixture. The quantity of secondary brewing ingredients includes at least one natural flavoring selected from a group consisting of: coffee, cocoa, yerba maté, guayusa, or combinations thereof. The secondary brewing ingredients can be provided in different forms as necessary, such as in powdered form, liquid form, etc. As can be seen in FIG. 7, the subprocess of infusing the secondary brewing ingredients into the infusion base includes the step of brewing the infusion base using the quantity of brewing water, the quantity of infusion materials, and the quantity of secondary brewing ingredients at the specific brewing temperature during Step D. In other embodiments, different brewing ingredients can be utilized for the present invention.

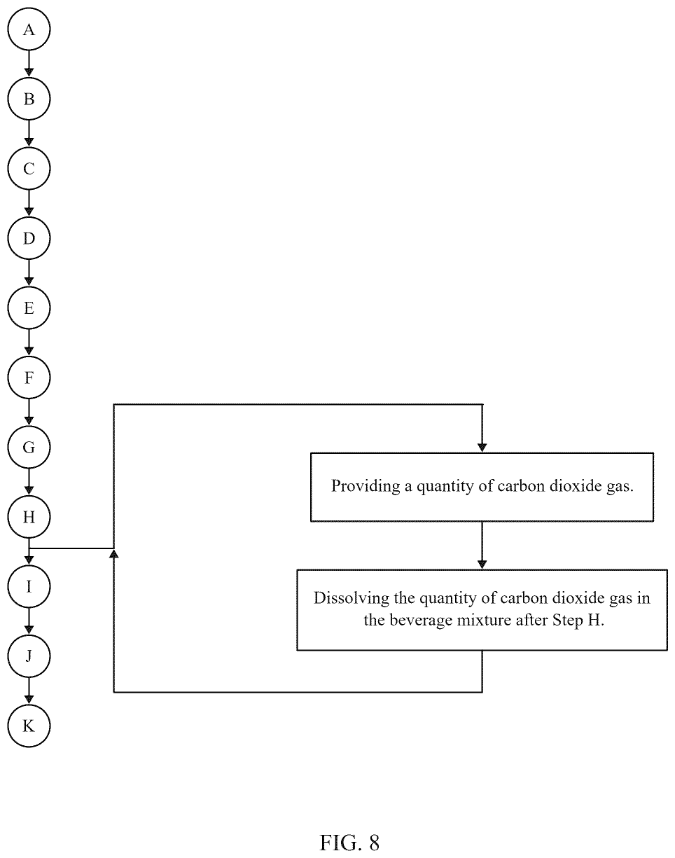

In some embodiments, the RTD infused beverage of the present invention can be provided as a carbonated beverage. To do so, the beverage ingredients may further include a quantity of Carbon Dioxide (CO2) gas. The quantity of CO2 gas can be introduced into the beverage mixture using different methods in order to carbonate the beverage mixture. As can be seen in FIG. 8, the subprocess of carbonating the beverage mixture generally includes the step of dissolving the quantity of CO2 gas in the beverage mixture after Step H. In other embodiments, different carbonation methods, such as fermentation, can be implemented.

As previously discussed, the manufacturing method of the present invention is designed for scalability to facilitate the commercial production of the RTD infused beverage. To further facilitate the scalability of the method, the quantity of infusion materials is preferably provided in a concentrate or extract form. By utilizing concentrates/extracts instead of the raw form of infusion materials, the brewing process can be performed more efficiently and effectively. Further, the concentrates/extracts can be provided by a third party or produced on-site depending on the technological capabilities of the manufacturing facility used. When producing the concentrates/extracts on-site, a quantity of extraction water and a quantity of maltodextrin can be used. The quantity of extraction water is used to process the raw form of the quantity of infusion materials, and the quantity of maltodextrin is used as a food-grade base for the concentrate/extract.

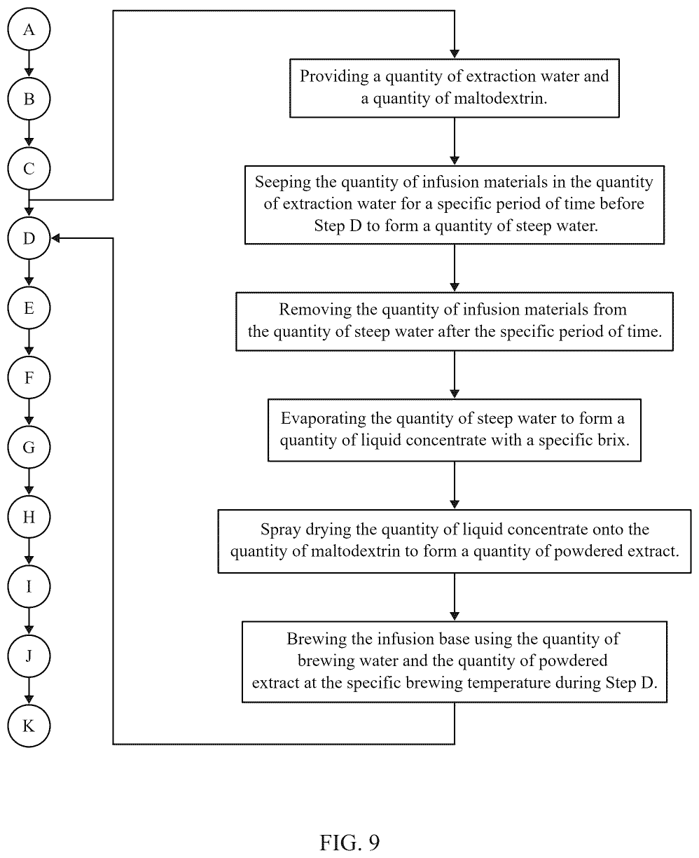

As can be seen in FIG. 9, the subprocess of producing concentrates/extracts from the infusion materials includes the steps of seeping the quantity of infusion materials in the quantity of extraction water for a specific period of time before Step D to form a quantity of steep water. This process, commonly known as aqueous extraction, allows the production of steep water infused with the infusion materials. For example, this can be steeping tea leaves in hot water. Then, the quantity of infusion materials is removed from the quantity of steep water after the specific period of time to obtain the quantity of steep water free from the infusion materials. Once the steep water is obtained, the quantity of steep water is evaporated to form a quantity of liquid concentrate with a specific brix. Evaporating the quantity of steep water allows the concentration of the infusion materials to increase. The specific brix corresponds to a predetermined amount of solids dissolves in the water. Then, the resulting quantity of liquid concentrate is spray dried onto the quantity of maltodextrin to form a quantity of powdered extract. The quantity of maltodextrin serves as the carrier for the dried concentrate so that the resulting extract is provided in powder form. Finally, using the produced powdered extract, the infusion base is brewed using the quantity of brewing water and the quantity of powdered extract at the specific brewing temperature during Step D. In other embodiments, different processes can be implemented to produce concentrates/extracts on-site.

### Exemplary Embodiments

In a first embodiment, the RTD infused beverage is provided as a black tea beverage. The beverage ingredients include plasma-treated whey and/or collagen protein isolates, stevia Reb M, Monk Fruit, and erythritol. The beverage mixture pH is adjusted to 3.5. Further, the beverage mixture is nitrogen dosed before sealing and then pasteurized after sealing to achieve a shelf-life stability of 12 months. The black tea beverage embodiment is substantially free of visible sedimentation.

In a second embodiment, the RTD infused beverage is provided as an RTD rooibos tisane beverage. The beverage ingredients include plasma-treated collagen and pea protein, and lemon juice. The beverage mixture pH is adjusted to 3.4. Further, the beverage mixture is nitrogen dosed before sealing and then pasteurized after sealing to achieve a shelf-life stability of 12 months. The RTD rooibos tisane beverage embodiment is also substantially free of visible sedimentation.

In a third embodiment, the RTD infused beverage is provided as an RTD hibiscus tisane beverage. The beverage ingredients include plasma-treated whey protein isolate, erythritol, and monk fruit. The beverage mixture pH is adjusted to 3.5. Further, the beverage mixture is nitrogen dosed before sealing and then pasteurized after sealing to achieve a shelf-life stability of 12 months. The RTD hibiscus tisane beverage embodiment is also substantially free of visible sedimentation.

In a fourth embodiment, the RTD infused beverage is provided as an RTD sparkling hibiscus tisane beverage. The beverage ingredients include plasma-treated whey protein isolate, erythritol, and monk fruit. The beverage mixture pH is adjusted to 3.4, and the beverage mixture is lightly carbonated. Further, the beverage mixture is nitrogen dosed before sealing and then pasteurized after sealing to achieve a shelf-life stability of 12 months. The RTD sparkling hibiscus tisane beverage embodiment is also substantially free of visible sedimentation.

Although the invention has been explained in relation to its preferred embodiment, it is to be understood that many other possible modifications and variations can be made without departing from the spirit and scope of the invention.

What is claimed is:

1. A method of manufacturing a ready-to-drink infused beverage containing atmospheric-plasma-treated protein, the method comprising the steps of:
A) providing a quantity of brewing water, a quantity of infusion materials, a quantity of protein, a quantity of sweeteners, and a quantity of preservatives;
B) providing at least one beverage container and a quantity of pH control agents;
C) atmospheric-plasma treating the quantity of protein to produce a quantity of plasma-treated protein;
D) brewing an infusion base using the quantity of brewing water and the quantity of infusion materials at a specific brewing temperature;
E) dispersing the quantity of plasma-treated protein into the infusion base to make a beverage mixture;
F) mixing the quantity of sweeteners and the quantity of preservatives into the beverage mixture;
G) adjusting the beverage mixture pH to match a specific mixture pH using the quantity of pH control agents, if the beverage mixture pH does not match the specific mixture pH;
H) filling the beverage container with the beverage mixture, if the beverage mixture pH matches the specific mixture pH;
I) nitrogen-dosing the beverage container, if the beverage container is filled;
J) sealing the beverage container, if the beverage container is nitrogen dosed; and
K) pasteurizing the beverage container, if the beverage container is sealed.

2. The method as claimed in claim 1 further comprising the steps of:
providing the quantity of protein in powder form; and
exposing the quantity of protein to non-thermal atmospheric plasma at a specific voltage and specific frequency for a specific period of time during step (B) to produce the quantity of plasma-treated protein.

3. The method as claimed in claim 2, wherein the quantity of plasma-treated protein has an average particle size in the range of 10 to 25 microns.

4. The method as claimed in claim 1, wherein a mass fraction of the quantity of protein in the beverage mixture is in the range of 2.0% to 6.5% by weight.

5. The method as claimed in claim 1, wherein the specific brewing temperature is below 60 degrees Celsius.

6. The method as claimed in claim 1, wherein the infusion base yields infusion solids in the range of 0.4% to 3.0%.

7. The method as claimed in claim 1, wherein the specific mixture pH is in the range of 3.0 to 4.2.

8. The method as claimed in claim 1, wherein the quantity of infusion materials includes at least one camellia-sinensis-based material selected from a group consisting of: black tea, green tea, oolong tea, white tea, Pu-erh tea, yellow tea, or combinations thereof.

9. The method as claimed in claim 1, wherein the quantity of infusion materials includes at least one non-camellia-sinensis-based material selected from a group consisting of: rooibos, hibiscus, chamomile, peppermint, ginger, lemongrass, lavender, yerba maté, guayusa, fennel, or combinations thereof

10. The method as claimed in claim 1, wherein the quantity of protein includes at least one protein material selected from a group consisting of: plant-derived protein, animal-derived protein, or combinations thereof.

11. The method as claimed in claim 1, wherein the quantity of sweeteners includes at least one low-calorie sweetener selected from a group consisting of: erythritol, stevia Reb M, monk fruit juice concentrate, allulose, or combinations thereof.

12. The method as claimed in claim 1, wherein the quantity of preservatives includes a quantity of mushroom extract.

13. The method as claimed in claim 1, wherein the quantity of preservatives includes at least one pH-reducing agent selected from a group consisting of: citric acid, ascorbic acid, phosphoric acid, malic acid, lactic acid, or combinations thereof.

14. The method as claimed in claim 1 further comprising the steps of:
providing a quantity of flavoring agents; and
mixing the quantity of flavoring agents into the beverage mixture after step (E).

15. The method as claimed in claim 14, wherein the quantity of flavoring agents includes at least one natural flavoring selected from a group consisting of: fruit extracts, botanical extracts, spice extracts, or combinations thereof.

16. The method as claimed in claim 1 further comprising the steps of:
providing a quantity of secondary brewing ingredients; and
brewing the infusion base using the quantity of brewing water, the quantity of infusion materials, and the quantity of secondary brewing ingredients at the specific brewing temperature during step (D).

17. The method as claimed in claim 16, wherein the quantity of secondary brewing ingredients includes at least one natural flavoring selected from a group consisting of: coffee, cocoa, yerba maté, guayusa, or combinations thereof.

18. The method as claimed in claim 1 further comprising the steps of:
providing a quantity of carbon dioxide gas; and
dissolving the quantity of carbon dioxide gas in the beverage mixture after step (H).

19. The method as claimed in claim 1 further comprising the steps of:
providing a quantity of extraction water and a quantity of maltodextrin;
seeping the quantity of infusion materials in the quantity of extraction water for a specific period of time before step (D) to form a quantity of steep water;
removing the quantity of infusion materials from the quantity of steep water after the specific period of time;
evaporating the quantity of steep water to form a quantity of liquid concentrate with a specific brix;
spray drying the quantity of liquid concentrate onto the quantity of maltodextrin to form a quantity of powdered extract; and
brewing the infusion base using the quantity of brewing water and the quantity of powdered extract at the specific brewing temperature during step (D).
